(19) United States
(12) Patent Application Publication
(10) Pub. No.: US 2020/0406463 A1
(43) Pub. Date: Dec. 31, 2020

(54) IMAGE PROCESSING SYSTEM AND INDUSTRIAL MACHINE

(71) Applicant: FANUC CORPORATION, Yamanashi (JP)

(72) Inventor: Yuta NAMIKI, Yamanashi (JP)

(73) Assignee: FANUC CORPORATION, Yamanashi (JP)

(21) Appl. No.: 16/889,954

(22) Filed: Jun. 2, 2020

(30) Foreign Application Priority Data
Jun. 25, 2019 (JP) 2019-116993

(51) Int. Cl. B25J 9/16

(52) U.S. Cl. CPC B25J 9/1697

(57) ABSTRACT

An image processing system according to an embodiment of the present disclosure includes: a visual sensor which photographs images; a first storage unit which stores image data photographed by the visual sensor and photography information including at least one of a processing result of the image data and machine control information of the industrial machine during photography; a second storage unit having larger capacity than the first storage unit, and to which the photography information is transmitted from the first storage unit; and a storage control unit which controls storing of the photography information by the first storage unit, and transmitting of the photography information from the first storage unit to the second storage unit, in which the storage control unit transmits the photography information that is old stored in the first storage unit to the second storage unit, and deletes the photography information stored that is old in the first storage unit.

This application is based on and claims the benefit of priority from Japanese Patent Application No. 2019-116993, filed on 25 Jun. 2019, the content of which is incorporated herein by reference.

### BACKGROUND OF THE INVENTION

### Field of the Invention

The present invention relates to an image processing system and an industrial machine.

### Related Art

For example, there are cases of combining an image processing device that has a visual sensor with an industrial machine such as a robot used in a manufacturing line of industrial goods, and confirming the position of a workpiece, or the like by way of an image processing device and compensating a target position of the robot, etc. In such an industrial machine, in the case of storing image data, and not being able to appropriately perform processing on a workpiece, it has been considered to configure to be able to confirm the image data and investigate the cause (for example, refer to Patent Document 1).

Patent Document 1: Japanese Patent No. 2921718

### SUMMARY OF THE INVENTION

Due to being large volume, the image data is saved in a storage device such as non-volatile memory which can be made large capacity for relatively low cost. However, since a high capacity storage device such as non-volatile memory has a relatively low recording speed, when saving the image data in an image processing device for industrial machines, there are cases where the cycle time of the industrial machine increases according to the waiting time to finish transferring the image data to the storage device. In addition, depending on the configuration of the industrial machine, there are cases where the visual sensor is retained by the robot or the like, and acquires the image data at different positions. In such a case, when trouble arises in the operation of the industrial machine, there is a possibility of not being able to accurately distinguish the cause for the trouble, if not confirming not only the image data, for example, but also the state of the industrial machine such as the position of the visual sensor when photographing the image data. For this reason, an image processing system and industrial machine have been desired for which rapid processing is possible, and it is possible to easily confirm the image data and image processing results, as well as the state of the industrial machine when photographing images.

An image processing system according to an aspect of the present disclosure is an image processing system which acquires image information in an industrial machine and performs image processing on the image information, the image processing system including: a visual sensor which photographs images; a first storage unit which stores image data photographed by the visual sensor and photography information including at least one of a processing result of the image data and machine control information of the industrial machine during photography; a second storage unit having larger capacity than the first storage unit, and to which the photography information is transmitted from the first storage unit; and a storage control unit which controls storing of the photography information by the first storage unit, and transmitting of the photography information from the first storage unit to the second storage unit, in which the storage control unit transmits the photography information that is old stored in the first storage unit to the second storage unit, and deletes the photography information stored that is old in the first storage unit.

According to the present invention, rapid processing is possible, and image data, image processing results and the state of an industrial machine when photographing images can be easily confirmed.

### BRIEF DESCRIPTION OF THE DRAWINGS

FIG. 1 is a schematic diagram showing the configuration of an industrial machine according to an embodiment of the present disclosure;

FIG. 2 is a flowchart showing a sequence of a photographing program executed in the industrial machine of FIG. 1;

FIG. 3 is a view schematically showing an image photographed according to the photographing program of FIG. 2;

FIG. 4 is a flowchart showing a sequence of storage of photography information according to the photographing program of FIG. 2; and

FIG. 5 is a flowchart showing a sequence of transmission of photography information performed in the industrial machine of FIG. 1.

### DETAILED DESCRIPTION OF THE INVENTION

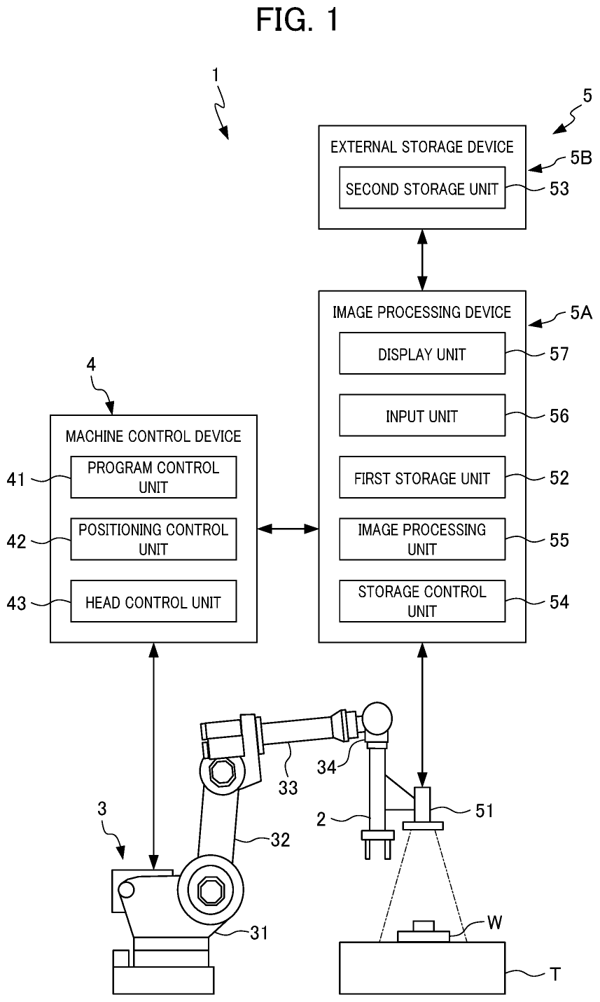

Hereinafter, an embodiment of the present disclosure will be explained while referencing the drawings. FIG. 1 is a schematic diagram showing the configuration of an industrial machine 1 of the embodiment of the present disclosure.

This industrial machine 1 includes: a processing head 2 which performs predetermined processing on a workpiece W placed on a table T; a positioning mechanism 3 which positions the processing head 2; a machine control device 4 which controls the processing head 2 and positioning mechanism 3; and an image processing system 5 which acquires image information, more specifically, photographs the workpiece W placed on the table T and specifies the position and orientation thereof.

The processing head 2, as an example, has a configuration suited to the processing to be performed on the workpiece W, such as a hand which can retain the workpiece W for movement, and a machining head that can perform machining such as welding, laser cutting, and cutting on the workpiece W. In the industrial machine 1 shown, the processing head 2 is a hand which retains the workpiece. In other words, the industrial machine 1 shown is a handling device which retains and moves the workpiece W.

The configuration of the positioning mechanism 3 is not particularly limited; however, it is possible to establish as a vertical articulated robot, rectangular robot, SCARA, parallel-link robot, or the like. It should be noted that the positioning mechanism 3 shown is a vertical articulated robot, and has a plurality of mobile members 31, 32, 33, 34 connected to each other to be rotatable, and in which the processing head 2 is connected to a leading end.

The machine control device 4 includes a program control unit 41 which determines operation of the processing head 2, positioning mechanism 3 and image processing system 5 according to an operating program such as a machining program provided in advance, a positioning control unit 42 which controls the positioning mechanism 3, and a head control unit 43 which controls the processing head 2, for example. The machine control device 4 can be configured by performing the appropriate programming in a programmable controller, numerical control device or the like, for example. The program control unit 41, positioning control unit 42 and head control unit 43 of the machine control device 4 are distinguished by the functions thereof, and may not be clearly distinguishable in the physical configuration and program configuration.

The program control unit 41 gives operation commands to the processing head 2, positioning mechanism 3 and image processing system 3 in accordance with an operating program such as a machining program. More specifically, the program control unit 41 gives a command to grip or release the workpieces to the processing head 2, gives a command specifying the position at which to move the processing head 2 to the positioning mechanism 3, and gives a command to confirm the position of the workpiece W to the image processing system 5.

In addition, the program control unit 41 is configured so as to input parameters which can specify the position and orientation of the processing head 2, such as the drive amount expressing the relative relationship of the mobile members 31, 32, 33, 34 obtained from the positioning control unit, to the image processing system 5 as machine control information. As necessary, information indicating the state of the processing head 2 controlled by the head control unit 43 and/or information indicating whether the processing on the workpiece W was appropriately executed by the processing head 2 may also be inputted to the image processing system 5 as part of the machine control information.

The positioning control unit 42 generates a drive signal to relatively rotate the mobile members 31, 32, 33, 34 of the positioning mechanism 3 in accordance with the command from the program control unit 41. In addition, the positioning control unit 42 outputs parameters defined as machine control information. As a specific example, the parameters outputted by the positioning control unit can be established as rotational position information of the plurality of drive motors driving the mobile members 31, 32, 33, 34, vector information indicating the coordinate position and orientation of the reference point of the processing head 2, and the like.

The head control unit 43 controls the operation of the processing head 2, and performs processing on the workpiece W. In addition, it may be configured so as to input the signal representing the state of the processing head 2 to the program control unit 41.

The image processing system 5 includes: a visual sensor 51 which photographs an image of the workpiece W; a relatively high speed (time required in writing is short) first storage unit 52 which stores image data photographed by the visual sensor 51 and photography information including at least either of processing results of this image data and machine control information during photography; a second storage unit 53 which is lower speed and larger capacity than the first storage unit 52, and to which photography information is transmitted from the first storage unit 52; a storage control unit 54 which controls storage of photography information by the first storage unit 52 and transmission of photography information from the first storage unit 52 to the second storage unit 53; an image processing unit 55 which processes the image data photographed by the visual sensor 51 and calculates the position and orientation of the workpiece W relative to the visual sensor 51; an input unit 56 allowing an operator to input information; and a display unit 57 which presents information to the operator.

The first storage unit 52, storage control unit 54, image processing unit 55, input unit 56 and display unit 57 are usually provided to a main processing device 5A arranged in the vicinity of the visual sensor 51. On the other hand, the second storage unit 53 may be provided to the main processing device 51A; however, as shown, it may be provided to an external storage device 5B connected to the main processing device 5A via a dedicated communication line with the main processing device 5A or a network. The main processing device 5A may be configured integrally with the machine control device 4, or may be configured separately from the machine control device 4. The external storage device 5B, i.e. second storage unit 53, may be jointly used by a plurality of image processing systems 5, i.e. plurality of industrial machines 1. As the dedicated communication line connecting the main processing device 5A and external storage device 5B, for example, USB (Universal Serial Bus), SATA (Serial AT Attachment), or the like can be exemplified, and may be a dedicated wireless communication line. In addition, as the network connecting the main processing device 5A and external storage device 5B, it is possible to exemplify wired LAN such as Ethernet, wireless LAN such as Wifi (registered trademark), or the like.

The visual sensor 51 can be configured by a camera having an optical system which forms an image of light from the subject, and a two-dimensional image sensor that converts the formed image into an electronic signal for every two-dimensional position. The visual sensor 51 may be positioned by the positioning mechanism 3. More specifically, the visual sensor 51 can be established as a configuration supported by the processing head 2 or the mobile member 34 which is an end of the positioning mechanism 3 to which the processing head 2 is connected.

Although not particularly limited, the first storage unit 52 can be configured by volatile memory such as DRAM or SRAM, for example. The first storage unit 52 has a capacity which can store at least one, and preferably a plurality of pieces of, past photography information. Since it is thereby possible to perform transmission of past photography information to the second storage unit 53 and erasing from the first storage unit 52, at the same time as processing current image data photographed by the visual sensor, it is possible to suppress the processing related to the first storage unit 52 from delaying operation of the industrial machine 1.

Although not particularly limited, the second storage unit 53 can be configured by non-volatile memory such as flash memory, a SSD (Solid State Drive), a hard disk drive, or an optical disk drive, for example. The second storage unit 53 has a capacity which can store the photography information acquired upon the running for a relative long period of the industrial machine 1.

The second storage unit 53 may store the photography information as data of a different format than the first storage unit 52. In other words, the storage control unit 54 may convert the photography information read from the first storage unit 52 into data of a different format, and write into the second storage unit 53. As an example, the second storage unit 53 may store character data of photography information in the first storage unit 52 as a compressed data file.

The storage control unit 54 generates photography information associating the image data supplied from the visual sensor 51 and the machine control information supplied from the machine control device 4, and causes this photography information to be stored in the first storage unit 52. In addition, the storage control unit 54 transmits the old photography information stored in the first storage unit 52 to the second storage unit 53, and deletes old photography information stored in the first storage unit 52. This storage control unit 54 can be realized causing the appropriate program to be executed in an arithmetic unit such as a CPU.

The storage control unit 54 may cause the photography information to the first storage unit 52 to be stored every time performing photography according to a request from the machine control device 4; however, it may be configured so as to cause only the required photography information to be stored in the first storage unit 52 in response to an instruction from the program control unit 41.

The photography information transmitted from the first storage unit 52 to the second storage unit 53 may be defined as the oldest photography information among all of the photography information stored by the first storage unit 52. By transmitting photography information stored by the first storage unit 52 to the second storage unit 53 in order from the older information, it is possible to preserve the photography information temporally stored by the first storage unit 52 without omission by causing to store in the second storage unit 53.

In addition, the photography information transmitted from the first storage unit 52 to the second storage unit 53 may be defined as the oldest photography information among the photography information having a specific attribute selected by the operator using the input unit 56, or selected in the operating program. By transmitting only photography information having a specific attribute from the first storage unit 52 to the second storage unit 53, it is possible to shorten the time required in order to transmit the photography information from the first storage unit 52 to the second storage unit 53, and suppress the transmission of photography information from the first storage unit 52 to the second storage unit 53 from producing wait time in operation of the industrial machine 1.

As the attribute deciding the necessity of transmission to the second storage unit 53, it is possible to exemplify whether or not the visual sensor 51 performed photography following which command of the operating program, or the like. Upon the industrial machine 1 making an operation in accordance with the operating program, there are cases where it is known in advance that it is important to confirm whether the setting of the position of the visual sensor 51 positioned by the positioning mechanism 3 according to a specific command of the operating program is appropriate. In this case, by transmitting and saving the control information including the image data photographed by the visual sensor 51 positioned according to this specific command and the machine control information specifying the state of the positioning mechanism at this time in the second storage unit 53, it is possible to confirm whether or not the operating program is appropriate.

The deletion of old photography information stored in the first storage unit 52 by the storage control unit 54 may be configured so as to delete this transmitted photography information continuously when transmitting photography information to the second storage unit 53. In addition, the deletion of old photography information stored in the first storage unit 52 by the storage control unit 53 may be configured so as to delete in order from the oldest photograph information, in the case of at least any of the first storage unit 52 capacity and the recording count exceeding a predetermined value. In addition, in the case of transmitting only photography information having a specific attribute to the second storage unit 53 as mentioned above, the transmitted photography information when transmitting photography information and the photography information of another attribute older than the transmitted photography information may be erased simultaneously, or only the transmitted photography information when transmitting photography information may be erased, and photography information of another attribute may be deleted in order from the oldest information when at least either of the capacity and recording count of the first storage unit 52 exceeds a predetermined value.

In addition, the storage control unit 54 may be able to select whether to transmit photography information from the first storage unit 52 to the second storage unit in accordance with an instruction by the operator using the input unit 56 or in accordance with the operating program. By configuring so as not to perform transmission of photography information from the first storage unit 52 to the second storage unit 53 during a preset operation of the industrial machine 1, it is possible to prevent an operational delay of the industrial machine 1 caused by recording of photography information in the first storage unit 52 by this amount, and improve the operating efficiency. In addition, by not performing the transmission of unnecessary photography information, it is possible to save the capacity of the second storage unit 53.

In addition, the storage control unit 54, in a case of at least either of the capacity and recording count of the first storage unit 52 exceeding a predetermined value, may be able to select to delete old photography information stored in the first storage unit 52, or inhibit new photography by the visual sensor 51. By inhibiting new photography by the visual sensor 51 in the case of the usage amount of the first storage unit 52 reaching the upper limit, in a case of creating a new operating program and confirming operation of the industrial machine 1, for example, it is possible to quickly confirm the photography information by way of the display unit 57 or the like, without writing back the photography information from the second storage unit 53 to the first storage unit 52.

The image processing unit 55 analyzes the image data photographed by the visual sensor 51 according to a well-known image processing technique, and determines the position and orientation of the workpiece W. This image processing unit 55 can be realized by causing the appropriate program to be executed in an arithmetic unit such as a CPU. It should be noted that the image processing unit 55 and storage control unit 54 are distinguished functionally, and may be realized by the same arithmetic unit.

The input unit 56 can have an input device such as a keyboard and switches which can be manipulated by the operator, for example. In addition, the input unit 56 may accept input from another control device or computer via a communication line or the like.

The display unit 57 can be established as a configuration having a display panel or the like which displays information to the operator. In addition, the display unit 57 may be a touch panel or the like which is formed integrally with the input unit 56.

Next, an example of operation of the industrial machine 1 will be explained step-by-step below. The industrial machine 1 can operate in accordance with the following such operating program.

### (Operating Program)

### 1: MOVE_TO P1

### 2: VISION_FIND “VP1”

### 3: MOVE_TO P2

### 4: VISION_FIND “VP2”

With this operating program, the positioning mechanism 3 moves the processing head 2 to the position defined as P1 according to the first line command. With the second line command, a photographing program named VP1 is executed. With this photographing program VP1, photographing is performed by the visual sensor 51 and calculation of the position and orientation of the workpiece W is performed based on the photographed image data, and writing to the first storage unit 52 of photography information is done according to the storage control unit 54.

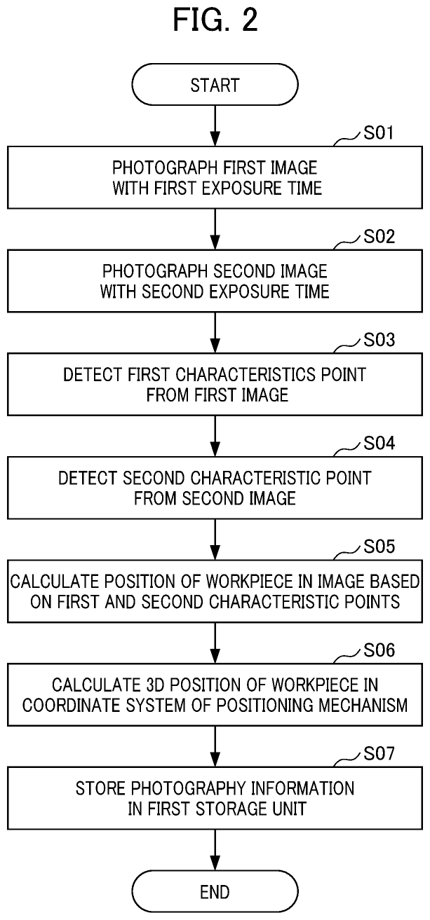

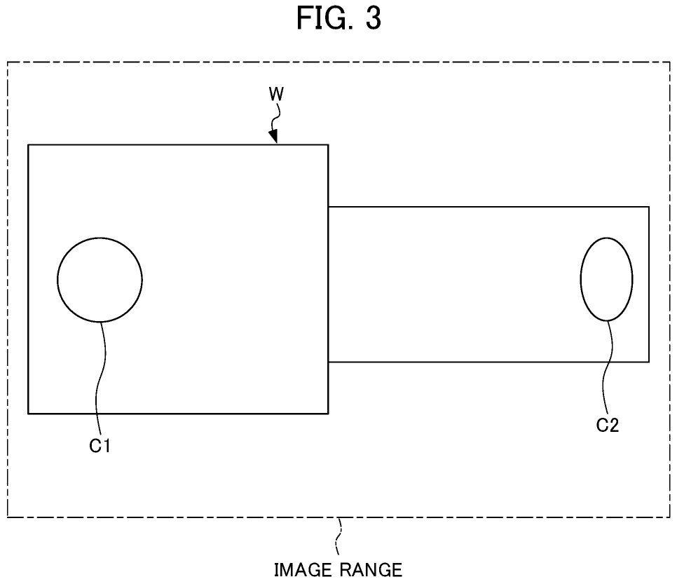

FIG. 2 shows the flow of processing related to photography information in the photographing program VP1. In this example, with the photographing program VP1, a first image is photographed with a first exposure time in Step S01, and a second image of the same angle of view as the first image is photographed with a second exposure time in Step S02. Next, a first characteristic point C1 of the workpiece W is detected from the first image in Step S03, and a second characteristic point C2 of the workpiece W is detected from the second image in Step S04 (refer to the photographed image exemplified in FIG. 3). Then, the position (coordinates and orientation) of the entire workpiece W is calculated from the positions of the two characteristic points C1, C2 in the first image and second image having the same angle of view in Step S05, and the position of the workpiece W in the coordinate system of the positioning mechanism 3 is calculated by considering the position of the visual sensor 51 during photography indicated by the machine control information in Step S06. Furthermore, in Step S07, photography information of the following such format is made to be stored in the first storage unit by the storage control unit 54.

(Photography information)
{
datetime: “2017/01/04 10:53:30”,
program: “VP1”,
command: “SNAPFIND”,
images: [

{

file: “img00001.png”,

snap_pos: [2.3, 1.1, 10.6, 0.1, 0.2, 10],
binning: 1,

},

{

file: “img00002.png”,

snap_pos: [2.3, 1.1, 10.6, 0.1, 0.2, 10],
binning: 1

}

],
found_pos: [
[2.3, 1.1, 10.6, 0.1, 0.2, 10],
[5.2, −2.3, 10.2, 0.1, 0.2, −1]
]
}

The above-mentioned photography information includes, as the machine control information, the name (attribute information) of the photographing program, data of the first image and the position of the visual sensor 51 during photography thereof, data of the second image and position of the visual sensor 51 during photography thereof, and as the image processing result, includes the calculated position of the workpiece W. It should be noted that, in the above-mentioned format of the photography information, the image data is made in a format referencing an external file; however, it may be written in the same file.

Furthermore, with the above-mentioned operating program, the positioning mechanism 3 makes the processing head 2 move to the position defined as P2, according to the third line command. Then, with the fourth line command, the photographing program named VP2 is executed. Herein as well, photography is performed by the visual sensor 51 and calculation of the position and orientation of the workpiece W is performed based on the photographed image data, and writing of photography information to the first storage unit 52 is done according to the storage control unit 54.

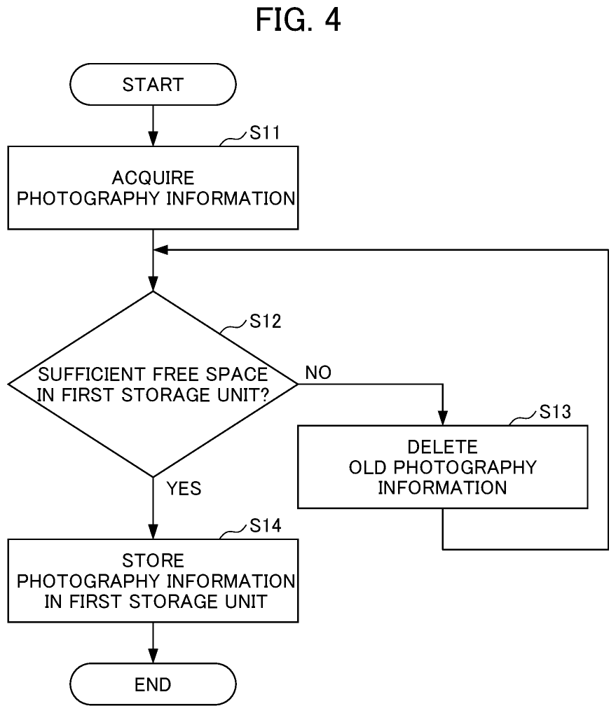

FIG. 4 shows the sequence of writing of photography information to the first storage unit 52 by the storage control unit 54. The storing of photography information by the first storage unit 52 first acquires photography information in Step S11, and confirms whether the free space of the first storage unit 52 is sufficient, i.e. free space is larger than the size of new photography information, in Step S12. In the case of the free space of the first storage unit 52 no longer being sufficient, the processing advances to Step S13, the free space is increased by deleting old photography information, the processing returns to Step S12, and confirms the free space of the first storage unit 52 again. In the case of the free space of the first storage unit 52 being sufficient, the processing advances to Step S14, and photography information is made to be stored by the first storage unit 52.

With the industrial machine 1, if photography of the second image in the photographing program VP1 in the second line of the operating program is finished, processing to perform movement of the processing head 2 in the third line may be executed; however, since it is not possible to handle the new image data until writing of photography information in the first storage unit 52 has completed, it is not possible to execute the fourth line of the photograph program VP2. Herein, by the first storage unit 52 being relatively high speed, it is possible to suppress a waiting time from arising from the execution of the photographing program VP1 until execution of the photographing program VP2.

In addition, with the industrial machine 1, the storage control unit 54 transmits the photography information of the first storage unit 52 to the second storage unit 53, in parallel with execution of the above-mentioned operating program. More specifically, the storage control unit 54 causes new photography information generated by the execution of the operating program to be stored in the first storage unit 52, and performs processing to transmit old photography information already stored in the first storage unit 52 to the second storage unit 53, when the first storage unit 52 is not occupied in order to store the new photography information.

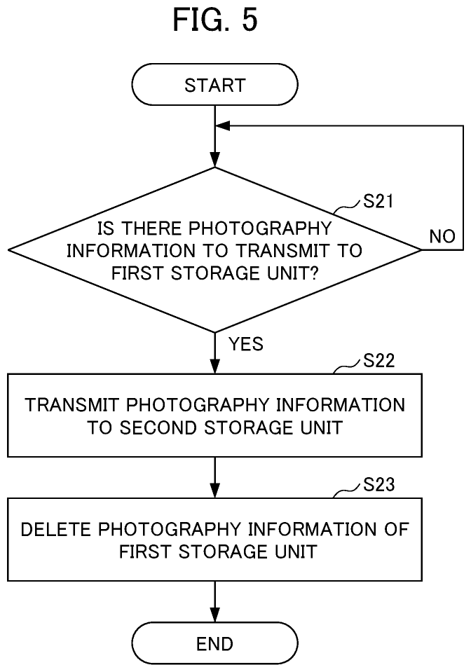

FIG. 5 shows a sequence of control related to the transmission of photography information to the second storage unit 53. Transmission control of photography information to the second storage unit 53 first confirms whether the photography information to be transmitted to the second storage unit 53 is present in the first storage unit 52 in Step S21. In the case of photography information to be transmitted to the second storage unit 53 being present in the first storage unit 52, the processing advances to Step S22 and transmits the photography information of the first storage unit 52 to the second storage unit 53, and the processing further advances to Step S23, and deletes the transmitted photography information from the first storage unit 52. It should be noted that, in the case of write processing of new photography information to the first storage unit 52 becoming necessary during transmission processing of photography information to this second storage unit 53, the transmission processing to the second storage unit 53 may be interrupted, and write processing of new photography information to the first storage unit 52 may be executed.

In the above way, the image processing system 5 of the industrial machine 1, by including the relatively high speed first storage unit 52 and relatively large capacity second storage unit 53, is capable of rapid processing, and can perform cause investigation by confirming the photography information in the case of trouble arising. In particular, the image processing system 5 generates and stores photography information including image data, image processing results and machine control information; therefore, not only the images photographed by the visual sensor 51, but also the state of the positioning mechanism 3 can be understood, and thus it is possible to more easily investigate the cause of failure.

Although an embodiment of the present disclosure has been explained above, the present invention is not to be limited to the aforementioned embodiment. In addition, the effects described in the present embodiment are merely listing the most favorable effects produced from the present invention, and the effects according to the present invention are not limited to those described in the present embodiment.

The industrial machine 1 may be a machine tool which positions a workpiece or tool by way of a positioning mechanism, and then machines the workpiece.

### EXPLANATION OF REFERENCE NUMERALS

1 industrial machine
2 processing head
3 positioning mechanism
4 machine control device
5 image processing system
31, 32, 33, 34 mobile member
41 program control unit
42 positioning control unit
43 head control unit
51 visual sensor
52 first storage unit
53 second storage unit
54 storage control unit
55 image processing unit
56 input unit
57 display unit
W workpiece

What is claimed is:

1. An image processing system which acquires image information in an industrial machine and performs image processing on the image information, the image processing system comprising:
a visual sensor which photographs images;
a first storage unit which stores image data photographed by the visual sensor and photography information including at least one of a processing result of the image data and machine control information of the industrial machine during photography;
a second storage unit having larger capacity than the first storage unit, and to which the photography information is transmitted from the first storage unit; and
a storage control unit which controls storing of the photography information by the first storage unit, and transmitting of the photography information from the first storage unit to the second storage unit,
wherein the storage control unit transmits the photography information stored in the first storage unit to the second storage unit, and deletes the photography information stored in the first storage unit.

2. The image processing system according to claim 1, wherein the storage control unit deletes from the first storage unit the photography information which was transmitted, when transmitting the photography information stored in the first storage unit to the second storage unit.

3. The image processing system according to claim 1, wherein the storage control unit can select whether to transmit the photography information from the first storage unit to the second storage unit.

4. The image processing system according to claim 1, wherein the storage control unit, in a case of at least either of a capacity and a recording count of the first storage unit exceeding a predetermined value, can select whether to delete the photography information that is old stored in the first storage unit, or to inhibit new photography by the visual sensor.

5. The image processing system according to claim 1, wherein the storage control unit is able to transmit only the photography information having a specific attribute from the first storage unit to the second storage unit.

6. The image processing system according to claim 1, wherein the storage control unit transmits the photography information from the first storage unit to the second storage unit via a dedicated communication line or a network.

7. An industrial machine comprising:
the image processing system according to claim 1;
a positioning mechanism which positions the visual sensor; and
a machine control device which controls the positioning mechanism, and supplies information of the positioning mechanism to the storage control unit as the machine control information.
